(19) United States
(12) Patent Application Publication
(10) Pub. No.: US 2012/0301713 A1
(43) Pub. Date: Nov. 29, 2012

(54) Transparent Composite Slate

(76) Inventor: Xiang Yang Hong, Xiamen City (CN)

(21) Appl. No.: 13/115,249

(22) Filed: May 25, 2011

(51) Int. Cl. B32B 27/06; B32B 5/00

(52) U.S. Cl. 428/339; 428/451

(57) ABSTRACT

A transparent composite slate is substantially made of a stone and a PS (polystyrene) plate. By means of the combination of the PS plate, the stone is strengthened to reduce its brittleness and to enhance its toughness. Further, in time of polishing, the combined PS plate only prevents the stone breaking but also promotes an ornamental effect of the stone. Therefore, the stone could be well used and concurrently promote the productivity of correlated finished product. While the strengthened stone provides an easy polish and a tough property, the thickness of the stone is thinner to increase the transparency of the finished product, for instance, the stone reaches 1 to 5 mm thick.

### BACKGROUND OF THE INVENTION

1. Field of the Invention

The present invention relates to a transparent composite slate.

2. Description of the Related Art

In the architecture, transparent slates are commonly applied to ornament or decorate the building. Generally, the transparent slate is made of stone such as marble, travertine, jade, or other translucent materials that could be see-through and directly polished. In time of polishing, the brittleness of the stone easily results in the broken slate. Therefore, the processing is accordingly difficult along with low yield of products and high processing costs leading to high prices. As a result, the stone product is difficult to be popular. Moreover, since the stone is subject to cracking, the current translucent slate is made thicker, about 12˜20 mm thick. Namely, the thickness of the slate is hard to be shrunk below 5 mm. Whereby, the transparent slate is actually opaque.

Therefore, the applicant dedicates himself to improving the current transparent slate and provides a transparent composite slate as claimed.

### SUMMARY OF THE INVENTION

The present invention is to provide a transparent composite slate that is easily processed so as to enhance the productivity, reduce the manufacturing cost, and promote the transparency of correlated product.

Afore object is achieved by following means:

A transparent composite slate is substantially made of a stone and a PS (polystyrene) plate.

Preferably, the stone is 1 to 5 mm thick.

Accordingly, a two-layered structure is substituted for a conventional one-layered structure. In processing, one side of the stone is attached by the PS plate, and the other side of the stone is polished, so that the transparent composite slate is made.

By means of the PS plate attaching to the stone, the stone remains less brittleness but more toughness. In time of polishing, the combination of the PS plate with the stone efficiently avoids breaking the stone and increases an ornamental effect and utilization of the stone, so that the complete product made by the stone could have a wide application. Further, while the stone is stuck by the PS plate, the polishing becomes easy and the stone is not subject to damage. Therefore, the stone can be further polished to lessen the thickness thereof. For example, the thick of the stone can reach to 1 to 5 mm, which promotes the transparency of the product.

Subsequent drawings and embodiment provide a clear detail of the present invention.

### BRIEF DESCRIPTION OF THE DRAWINGS

FIG. 1 is a schematic view showing the present invention.

### DETAILED DESCRIPTION OF THE PREFERRED EMBODIMENTS

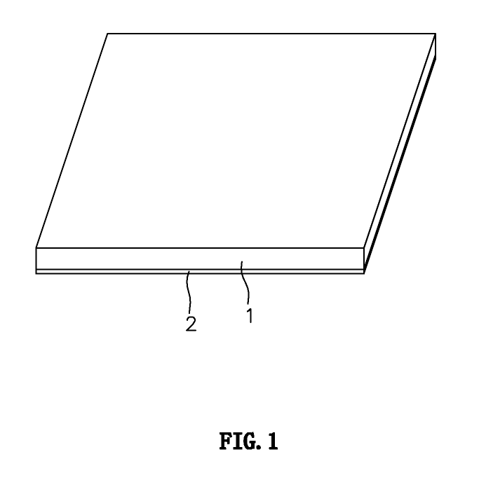

Referring to FIG. 1, a transparent composite slate is substantially made of a stone 1 and a PS plate 2.

A two-layered structure of the present invention is substituted for the conventional single-layered structure. Namely, the PS plate 2 and the stone 1 are combined for decreasing the brittleness but increasing the toughness of the stone. In time of polishing, the PS plate 2 efficiently prevents the stone 1 from being broken. Accordingly, the advanced stone has a promoted ornamental effect and increased utilization, which provides a wide application of the complete product. While the present invention is further polished to a thinner state, namely, the thickness of the stone 1 is polished to 1 to 5 mm, the transparency of the present invention is more satisfactory.

Above embodiments demonstrate the inventive steps of the present invention for the patentability. Embodiments presented in the present invention do not limit the creative, novel, and non-obvious spirits involved in the techniques and functions of the same.

I claim:

1. A transparent composite slate being composed by a stone and a PS plate.

2. The slate as claimed in claim 1, wherein, the stone is 1 to 5 mm thick.
